(19) United States
(12) Patent Application Publication
(10) Pub. No.: US 2026/0201265 A1
(43) Pub. Date: Jul. 16, 2026

(54) FRICTION-REDUCING AND WEAR-RESISTANT POLYAMIDE-IMIDE COMPOSITE MATERIAL, PREPARATION METHOD THEREOF AND APPLICATION METHOD THEREFOR

(71) Applicant: Wuhan Research Institute of Materials Protection, Wuhan (CN)

(72) Inventors: Shengpeng Zhan, Wuhan (CN); Jinming Ma, Wuhan (CN); Dan Jia, Wuhan (CN); Haitao Duan, Wuhan (CN); Yijie Jin, Wuhan (CN); Xiaojing Li, Wuhan (CN); Tian Yang, Wuhan (CN); Lixin Ma, Wuhan (CN)

(21) Appl. No.: 19/366,575

(22) Filed: Oct. 23, 2025

(30) Foreign Application Priority Data
Jan. 13, 2025 (CN) 202510047244.3

(51) Int. Cl. C10M 125/22; C09C 1/00; C09C 3/12; C10M 107/44; C10M 169/04; C10M 177/00; C10N 30/04; C10N 30/18; C10N 50/02; C10N 70/00

(52) U.S. Cl. CPC C10M 125/22; C09C 1/0081; C09C 3/12; C10M 107/44; C10M 169/04; C10M 177/00; C01P 2004/03; C10M 2201/14; C10M 2217/0443; C10N 2030/04; C10N 2030/18; C10N 2050/02; C10N 2070/00

(57) ABSTRACT

A friction-reducing and wear-resistant polyamide-imide composite material, a preparation method thereof and an application method therefor are provided, which relate to the technical field of polymer materials. The composite material includes the following raw materials in part by weight: 100 parts of basic slurry, 0.1-20 parts of functional filler, 0-50 parts of diluent, 0.1-1 part of defoamer, and 0.1-1 part of dispersant. The basic slurry is aqueous polyamide-imide emulsion. The functional filler is a biomass carbon composite molybdenum disulfide material treated with a siloxane coupling agent, and a source of biomass carbon is cattail-derived carbon fibers. The composite material has advantages of low friction coefficient and wear rate, wide raw material sources, environmental friendliness, and high dispersion stability. The preparation method has a simple and convenient process and can meet demands for planned production. The material has broad application prospects as a friction-reducing and wear-resistant material in mechanical engineering materials.

### TECHNICAL FIELD

The disclosure relates to the technical field of polymer materials, and more particularly to a friction-reducing and wear-resistant polyamide-imide composite material, a preparation method thereof and an application method therefor.

### BACKGROUND

Polymer coating materials have good wear resistance and corrosion resistance. The polymer coating materials are commonly used in environments such as mechanical equipment, ships, and buildings that are required to withstand high temperatures or chemical erosion. In general industry, polyamide-imide coatings can be applied to bearings and wear-resistant components, as well as components demanding high strength and hardness. However, pure polyamide-imide coatings have relatively high friction coefficients and wear rates. By adjusting the composition and surface state of the polymer coatings, its friction coefficient and wear rate can be effectively controlled and optimized.

Molybdenum disulfide (MoS₂) and carbon-based materials demonstrate significant effectiveness in the field of friction reduction and lubrication. Both the MoS₂ and the carbon-based materials can form lubricating films at the interface, which markedly reduce the friction coefficient. Introducing the carbon materials into pure MoS₂ can modify a surface morphology of MoS₂, resulting in a more uniform and continuous friction film. This contributes to reduced friction and wear, thereby extending a service life of the materials. Furthermore, the corrosion resistance of the carbon materials can enhance the overall corrosion resistance of the composite material, which is particularly important for applications in harsh environments.

Currently, the carbon materials used for this purpose are primarily high-purity graphite, and carbon nanotubes, which are procured from laboratories. The raw materials for these often originate from non-renewable fossil fuels such as methane and ethylene, which involves high production process requirements and costs. In contrast, biomass carbon is derived from biomass waste, which is a renewable resource and offers advantages in terms of cost and environmental friendliness. With technological advancements, the performance of the biomass carbon is continuously improving, which shows potential to replace traditional carbon materials in more fields.

For example, a Chinese patent application publication No. CN107298442A discloses a biomass carbon/molybdenum disulfide nanocomposite material and its preparation method. This method utilizes corn stalks to prepare biomass carbon through hydrothermal method and calcination, followed by a one-step hydrothermal process to grow petal-like molybdenum disulfide nanomaterials on the porous biomass carbon. However, compared to traditional carbon materials, using general biomass carbon materials in polyamide-imide often encounters a technical problem of poor dispersibility of the composite within the polyamide-imide emulsion. General biomass carbon particles are prone to agglomeration due to their high specific surface area. The agglomerated particles form larger aggregates, thereby increasing the difficulty of dispersion in the emulsion. Moreover, a Brownian motion effect of larger particles weakens, making them more susceptible to sedimentation and exacerbating dispersion difficulties. Consequently, it is challenging for the biomass carbon/MoS₂ composite to achieve the intended application effects in polyamide-imide, which is intuitively reflected in unsatisfactory lubricating performance and high friction coefficient and wear of the composite material.

Therefore, it is of positive significance for expanding the application of polyamide-imide coatings that providing a friction-reducing and wear-resistant polyamide-imide composite material and a preparation method thereof, which fully leverages the advantages of the biomass carbon materials and overcomes the aforementioned defects in the related art, to address the issues of high friction coefficient and wear in polyamide-imide materials in application.

### SUMMARY

In view of the aforementioned defects in the related art, in the first aspect of the disclosure, a friction-reducing and wear-resistant polyamide-imide composite material with low friction coefficient and wear rate, wide raw material sources, environmental friendliness, and high dispersion stability is provided, which includes the following raw materials in part by weight:
100 parts of basic slurry, 0.1-20 parts of functional filler, 0-50 parts of diluent, 0.1-1 part of defoamer, and 0.1-1 part of dispersant; where the basic slurry is aqueous polyamide-imide emulsion; the functional filler is a biomass carbon composite molybdenum disulfide material treated with a siloxane coupling agent, and a source of biomass carbon is derived from cattail-derived carbon fibers.

The cattail-derived carbon fibers can be obtained by carbonizing clean cattail fibers. The cattail fibers have a high wax content. In practical operation, those skilled in the art may wash the cattail fibers with suitable solvents such as water and ethanol (washing with water can remove solid impurities such as sediment and dust from the fibers, while washing with ethanol can dissolve and remove some organic impurities such as oils and waxes), followed by drying and then carbonization.

In an embodiment, a preparation method of the cattail-derived carbon fibers includes: removing impurifies from surfaces of the cattail fibers to obtain impurifies-removed cattail fibers, and drying the impurifies-removed cattail fibers at a temperature of 700° C. to 900° C. for carbonization for 2 hours (h) to 4 h, to obtain the cattail-derived carbon fibers.

In practical operation, those skilled in the art can select suitable types of additives according to actual needs and conditions.

Water, ethanol, and isopropanol are suitable diluents for the polyamide-imide emulsion of the disclosure. Amounts of the water, the ethanol and the isopropanol can be selected and adjusted according to parameters such as viscosity of the used basic slurry, to give the system good processability. The water excels in environmental friendliness, safety, and cost-effectiveness. The ethanol offers advantages in solubility, volatility, and antibacterial properties. The isopropanol performs well in high dissolving power, low toxicity, and good volatility.

In an embodiment, the diluent is at least one of water, ethanol and isopropanol.

Products such as HLD-6, HLD-8ks, and HLD-11c from Silcona® (Silcona GmbH&CO. KG company) are suitable types of dispersants for the disclosure, which are water-based dispersants. HLD-6 is a polyester with pigment affinity, with a solid content of 89.0-91.0%, and HLD-6 improves production efficiency through its wide applicability. HLD-8ks is a polymeric dispersant with pigment affinity, with a solid content of 79%-81%, and HLD-8ks optimizes the dispersion effect of fillers and reduces process complexity through its specially formulated design. HLD-11c is a non-ionic polymer with a solid content of 49-51%, and HLD-11c features environmental characteristics and is designed specifically for aqueous systems. These dispersants have excellent wetting and stabilizing properties, and can effectively prevent functional fillers from agglomerating in aqueous systems. It should be noted that although the dispersants are conventional additives in coatings and adding them can improve the dispersibility of components to a certain extent, in the application context of the disclosure, issues such as agglomeration and poor dispersion of the biomass carbon materials still cannot be fully resolved merely by increasing the amount of dispersant.

In an embodiment, the dispersant is at least one of HLD-6, HLD-8ks and HLD-11c.

BYK series defoamers are high-performance additives produced by German company BYK, which are used to reduce foam problems in coating production. Among them, defoamers such as BYK-012, BYK-014, and BYK-016 can rapidly reduce a surface tension of the mixed system, destroy the foam structure, and inhibit the generation of new foam. The three defoamers are a mixture of foam breaking polymers and hydrophobic particles, free of mineral oil and volatile organic compounds.

In an embodiment, the defoamer is at least one of BYK-012, BYK-014 and BYK-016.

In the second aspect of the disclosure, a preparation method of the friction-reducing and wear-resistant polyamide-imide composite material is provided, which has a simple and convenient process. The preparation method includes:
step 1, mixing the cattail-derived carbon fibers, ammonium molybdate tetrahydrate and thiourea in water to obtain a mixed solution; and performing a hydrothermal reaction on the mixed solution to obtain a crude product, and recycling and purifying the crude product to obtain the biomass carbon composite molybdenum disulfide material;
step 2, treating the biomass carbon composite molybdenum disulfide material with a siloxane coupling agent, adding the biomass carbon composite molybdenum disulfide material treated with the siloxane coupling agent into the aqueous polyamide-imide emulsion to obtain a mixture, and adding the diluent, the dispersant and the deformer into the mixture to mix and disperse, to obtain a coating mixture; and
step 3, coating the coating mixture on a surface of a substrate, allowing the coated coating mixture to surface-dry at room temperature to obtain a surface-dried coating mixture, curing the surface-dried coating mixture to obtain a cured coating mixture, and annealing the cured coating mixture naturally to obtain the friction-reducing and wear-resistant polyamide-imide composite material.

In an embodiment, in step 1, an amount of the cattail-derived carbon fibers is in a range of 0.4 grams (g) to 1.0 g; an amount of the ammonium molybdate tetrahydrate is in a range of 0.6 g to 1.0 g, an amount of the thiourea is in a range of 1.8 g to 3.0 g, and a weight ratio between the ammonium molybdate tetrahydrate to the thiourea is 1:3; and an amount of the water is in a range of 40 milliliters (mL) to 60 mL.

In an embodiment, in step 1, a temperature of the hydrothermal reaction is in a range of 150° C. to 200° C., and a period of the hydrothermal reaction is in a range of 6 h to 12 h.

The biomass carbon composite molybdenum disulfide material can be treated with the silane coupling agent by using conventional methods in the art, and then added to the aqueous polyamide-imide emulsion. The silane coupling agent acts as a bridge between the inorganic filler (i.e., biomass carbon composite molybdenum disulfide material) and the organic polymer matrix (i.e., aqueous polyamide-imide emulsion), to enhance the chemical affinity between the inorganic filler and the organic polymer matrix, and reduce interface defects. As demonstrated in the embodiments of the disclosure, 2 g of the biomass carbon composite molybdenum disulfide material is taken, and added with 1 mL of KH560 (γ-glycidyloxypropyltrimethoxysilane) and 99 mL of ethanol, followed by heating and stirring at 60° C. for 3 h, to obtain the biomass carbon composite molybdenum disulfide material treated with the siloxane coupling agent. Those skilled in the art may also employ other methods to complete this treatment.

In an embodiment, in step 3, a temperature of the curing is in a range of 270° C. to 320° C., and a period of the curing is in a range of 3 h to 8 h.

In the third aspect of the disclosure, an application method of the friction-reducing and wear-resistant polyamide-imide composite material of the first aspect of the disclosure or the friction-reducing and wear-resistant polyamide-imide composite material prepared by the preparation method of the second aspect of the disclosure is provided, including:
using the friction-reducing and wear-resistant polyamide-imide composite material as a friction-reducing and wear-resistant material in mechanical engineering.

Based on the above technical solution, the inventive concept of the disclosure lies in using cattail-derived carbon fibers as the biomass carbon material. The structure and other properties of the biomass carbon are highly correlated with its source biomass material. Compared to ordinary biomass carbon materials, cattail-derived carbon fibers possess a specific micro/nano structure. Structurally, cattail fibers have a multi-cavity structure, characterized by being lightweight and structurally stable. The main fiber bundles consist of thin-walled cells and solid stone cells, which exhibits high tensile strength and specific modulus. The branched fiber bundles consist of multiple “semi-honeycomb” shaped thin-walled cells, where internal transverse diaphragms divide the shaped thin-walled cells into multiple open cavities. This structural feature makes the cattail branched fiber bundles lightweight, structurally stable, and gives them good oil adsorption and storage capacity. The aforementioned structure can provide stable physical support, thereby protecting the nanoparticles from agglomeration, which is beneficial for improving their dispersibility in the polyamide-imide emulsion. By introducing the cattail-derived carbon fiber composite MoS₂ material, the disclosure utilizes the self-lubricating property of MoS₂ itself combined with the stability and high load-bearing capacity advantages of this carbon material, which fully exerts the synergistic effect between the cattail-derived carbon fibers and MoS₂, thereby effectively controlling the friction coefficient and the wear rate of the polymer coatings.

Compared to the related art, the disclosure has the following advantages and beneficial effects.

The disclosure provides a friction-reducing and wear-resistant polyamide-imide composite material, which has the advantages of low friction coefficient, low wear rate, wide raw material sources, environmental friendliness, and high dispersion stability.

The disclosure provides a preparation method of the friction-reducing and wear-resistant polyamide-imide composite material, which has a simple and convenient process and can meet demands for planned production.

The disclosure provides an application method of the friction-reducing and wear-resistant polyamide-imide composite material, which has broad application prospects as a friction-reducing and wear-resistant material in mechanical engineering materials.

### BRIEF DESCRIPTION OF DRAWINGS

FIG. 1 illustrates a schematic diagram of material objects of wild cattail and cattail fibers.

FIG. 2A illustrates a scanning electron micrograph of a biomass carbon composite molybdenum disulfide material, and a scale bar is 10 microns (μm).

FIGS. 2B-2E illustrate elemental distribution maps of the biomass carbon composite molybdenum disulfide material.

FIG. 3A illustrates a scanning electron micrograph of a friction-reducing and wear-resistant polyamide-imide composite material prepared in an embodiment 1.

FIGS. 3B-3F illustrate elemental distribution maps of the friction-reducing and wear-resistant polyamide-imide composite material prepared in the embodiment 1.

FIG. 4 illustrates a schematic diagram of friction coefficient curves of materials of embodiments 1-3 and a control group under a dry friction condition and a white oil condition with a load of 10 newtons (N).

FIG. 5 illustrates a schematic diagram of friction coefficient curves of the materials of the embodiments 1-3 and the control group under the dry friction condition and the white oil condition with a load of 5 N.

FIG. 6A illustrates a white light interferometry diagram of wear scars of a pure polyamide-imide coating under the dry friction condition with the load of 10 N.

FIG. 6B illustrates a white light interferometry diagram of wear scars of the material obtained in the embodiment 1 under the dry friction condition with the load of 10 N.

FIG. 6C illustrates a white light interferometry diagram of wear scars of the material obtained in the embodiment 2 under the dry friction condition with the load of 10 N.

FIG. 6D illustrates a white light interferometry diagram of wear scars of the material obtained in the embodiment 3 under the dry friction condition with the load of 10 N.

FIG. 7A illustrates a white light interferometry diagram of wear scars of the pure polyamide-imide coating under the dry friction condition with the load of 5 N load.

FIG. 7B illustrates a white light interferometry diagram of wear scars of the material obtained in the embodiment 1 under the dry friction condition with the load of 5 N.

FIG. 7C illustrates a white light interferometry diagram of wear scars of the material obtained in the embodiment 2 under the dry friction condition with the load of 5 N.

FIG. 7D illustrates a white light interferometry diagram of wear scars of the material obtained in the embodiment 3 under the dry friction condition with the load of 5 N.

### DETAILED DESCRIPTION OF EMBODIMENTS

The disclosure is further described through embodiments below, but the disclosure is not limited to ranges of the embodiments. The experimental methods without specific conditions specified in the following embodiments shall be selected according to conventional methods and conditions, or according to the product specification.

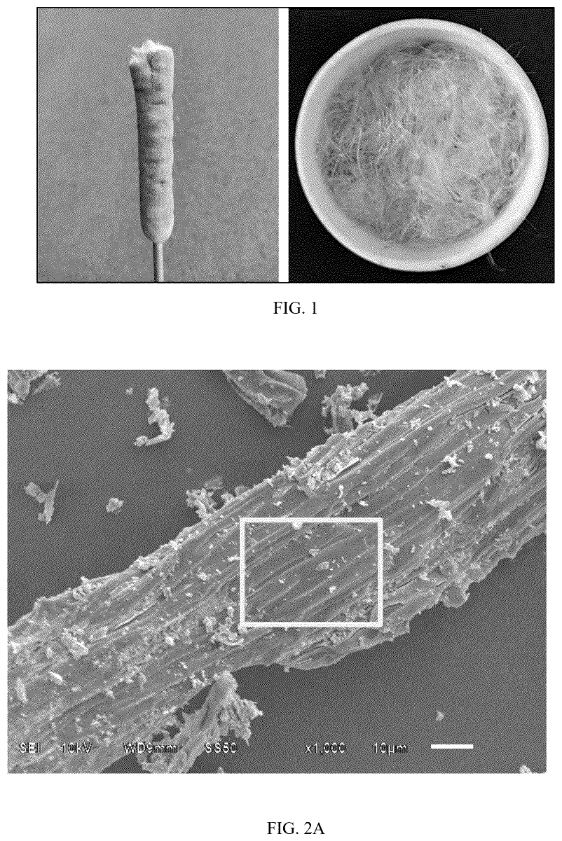

In the following embodiments, material object images of the used wild cattail and cattail fibers are shown in FIG. 1. A preparation method of cattail-derived carbon fibers are as follows. The cattail fibers are cleaned with water and ethanol to remove surface impurifies, and the impurifies-removed cattail fibers are dried and heated to 800° C. for carbonization for 2 h to obtain the cattail-derived carbon fibers.

### Embodiment 1

A friction-reducing and wear-resistant polyamide-imide composite material of the embodiment is prepared by the following method.

In step 1, 0.6 g of cattail-derived carbon fibers, 0.8 g of ammonium molybdate tetrahydrate and 2.4 g of thiourea are added into 50 mL of deionized water, and magnetically stirred for 30 minutes (min) to mix evenly, to thereby obtain a mixed solution. The mixed solution is transferred to an autoclave to perform a hydrothermal reaction. Heating and holding conditions of the autoclave are set as 160° C. for 10 h. After the hydrothermal reaction is completed and the autoclave cools naturally, a sample is taken out of the cooled autoclave, then centrifuged, washed, and vacuum dried to obtain a biomass carbon composite molybdenum disulfide material.

In step 2, 2 g of the biomass carbon composite molybdenum disulfide material is taken out and added with 1 mL of KH560 and 99 mL of ethanol to obtain a first mixture. The first mixture is heated at 60° C. and stirred for 3 h, followed by centrifuging, washing, and vacuum drying to obtain a biomass carbon composite molybdenum disulfide material treated with a siloxane coupling agent (i.e., KH560). 0.1 g of the biomass carbon composite molybdenum disulfide material treated with the siloxane coupling agent is added into 10 g of aqueous polyamide-imide emulsion to obtain a second mixture. 0.1 weight percent (wt. %) of polymer water-based defoamer and 0.1 wt. % of dispersant are added into the second mixture to obtain a third mixture. The third mixture is mixed evenly at a speed of 500 revolutions per minute (rpm) to obtain a coating mixture.

In step 3, the coating mixture is poured into a spray gun, and evenly sprayed onto a sandblasted aluminum (Al) sheet (i.e., substrate) through the spray gun. After allowing the coating mixture to surface-dry at room temperature, the Al sheet sprayed with the coating mixture is placed in an oven, and the heating and holding conditions of the oven are set as 120° C. for 1 h, and then the temperature is raised to 270° C. for 1 h, so as to complete curing to obtain a cured coating mixture. The curing coating mixture is naturally annealed to form a film to thereby obtain a friction-reducing and wear-resistant polyamide-imide composite material, named PAI-1% filler.

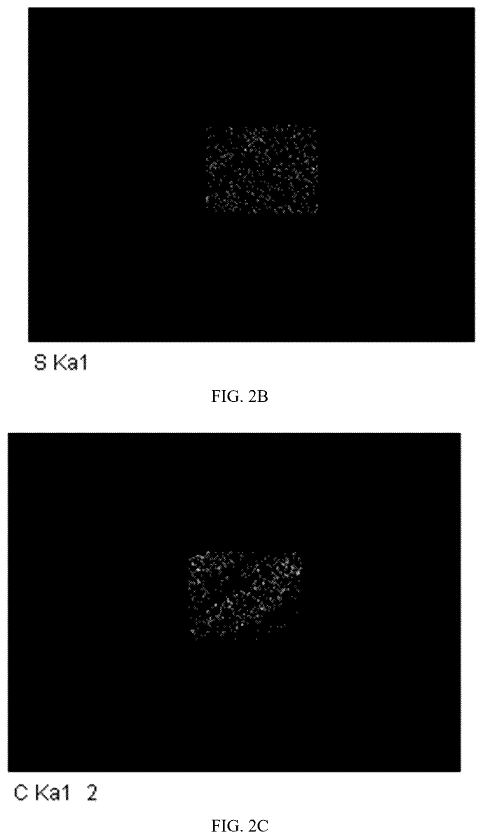

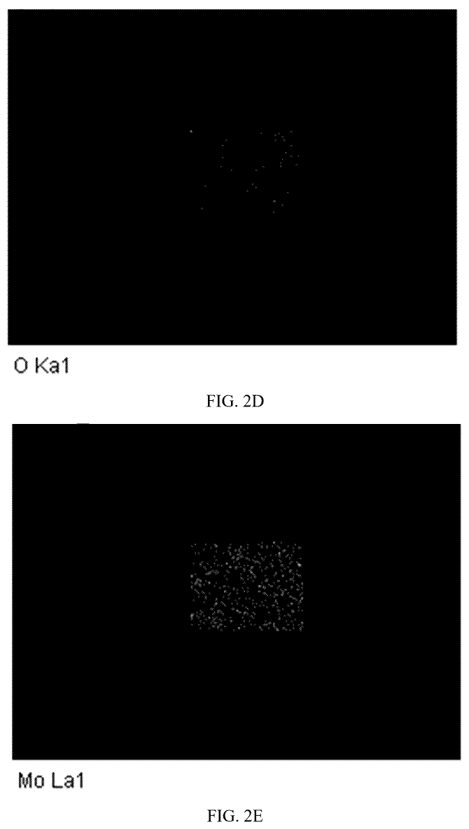

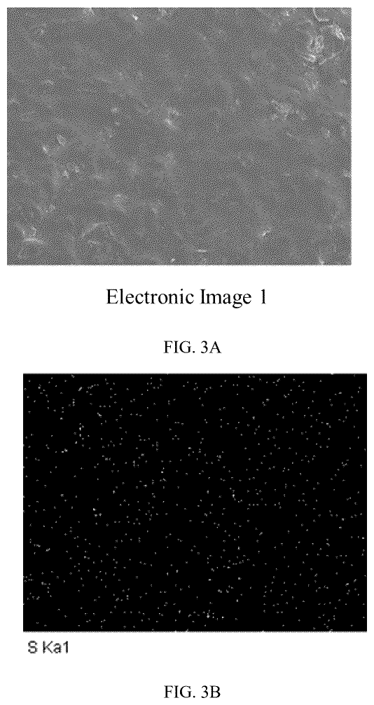

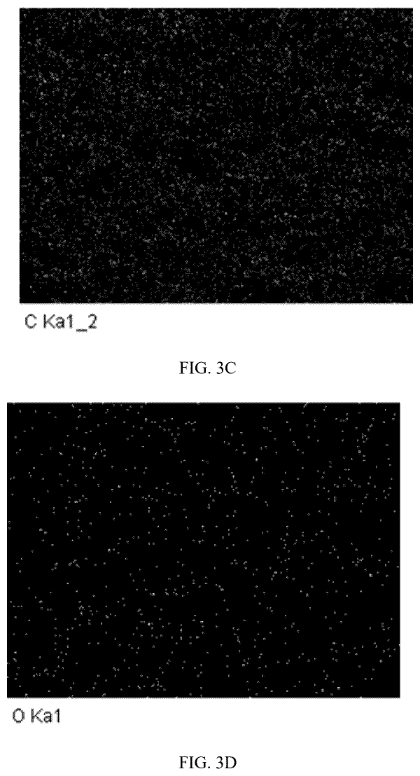

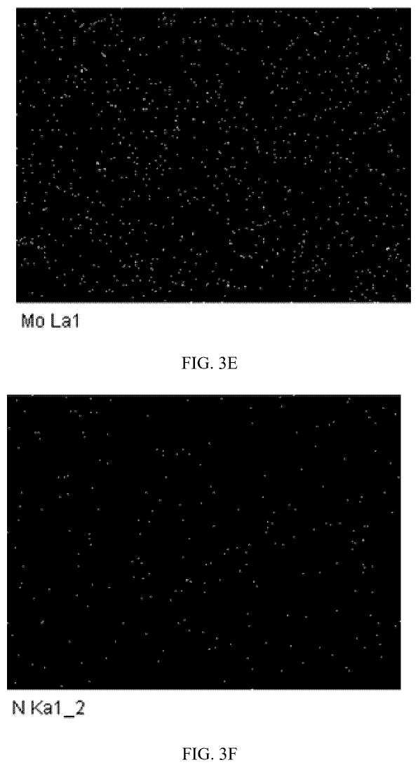

The embodiment firstly adopts scanning electron microscopy and elemental distribution analysis to characterize the biomass carbon composite molybdenum disulfide material. The scanning electron micrograph and elemental distribution maps of the biomass carbon composite molybdenum disulfide material are shown in FIGS. 2A-2E. It can be seen from FIGS. 2A-2E that sulfur (S), molybdenum (Mo) and carbon (C) are uniformly distributed in the elemental distribution maps, which indicates that the MoS₂ particles prepared by the hydrothermal method successfully grew on the cattail-derived carbon and are uniformly dispersed. The prepared friction-reducing and wear-resistant polyamide-imide composite material is further analyzed by using the same method, and the characterization results are shown in FIGS. 3A-3F. It can be seen from FIGS. 3A-3F that the biomass carbon composite molybdenum disulfide material is uniformly dispersed in the polyamide-imide material, and no significant agglomeration is observed.

### Embodiment 2

The embodiment is substantially identical to the embodiment 1, with the only difference being that 0.2 g of the biomass carbon composite molybdenum disulfide material treated with the siloxane coupling agent is added into 10 g of the polyamide-imide emulsion. The obtained friction-reducing and wear-resistant polyamide-imide composite material is named as PAI-2% filler.

### Embodiment 3

The embodiment is substantially identical to the embodiment 1, with the only difference being that 0.3 g of the biomass carbon composite molybdenum disulfide material treated with the siloxane coupling agent is added into 10 g of the polyamide-imide emulsion. The obtained friction-reducing and wear-resistant polyamide-imide composite material is named as PAI-3% filler.

### Embodiment 4

The embodiment studies an application effect of the friction-reducing and wear-resistant polyamide-imide composite material under a dry friction condition and a white oil condition.

A tribological performance testing is performed as follows. A reciprocating friction and wear tester is used to perform tribological performance testing on the above polyamide-imide composite materials under the dry friction condition and the white oil condition. A kinematic pair is GCr15 (a high-carbon chromium bearing steel, equivalent to AISI 52100) bearing steel balls with a diameter of 6.35 millimeters (mm). The loads are 5 N and 10 N, the frequency is 2 hertz (Hz), and the test duration is 20 min. After the friction tests, a white light confocal three-dimensional profiler is used to characterize the three-dimensional surface morphology of the wear scars, to analyze the width and depth of the wear scars.

In the tribological performance testing, a pure polyamide-imide sample is used as a control group, which is prepared as follows.

10 g of aqueous polyamide-imide emulsion is stirred at a speed of 500 rpm for 5 min to obtain stirred emulsion. 2 drops of polymeric defoamer is added into the stirred emulsion to stir for defoaming, to thereby obtain a defoamed material. The defoamed material is poured into a spray gun, and evenly sprayed in a layer onto a sandblasted Al sheet. After natural surface drying, the Al sheet sprayed with the defoamed material is placed in an oven for curing. The oven temperature is raised to 280° C. After a curing time of 3 h, the cured material is naturally annealed to the room temperature. The Al sheet is taken out, cleaned with ethanol, and the surface of the Al sheet is blown dry with a nitrogen gun, to obtain the pure polyamide-imide material, named as pure PAI.

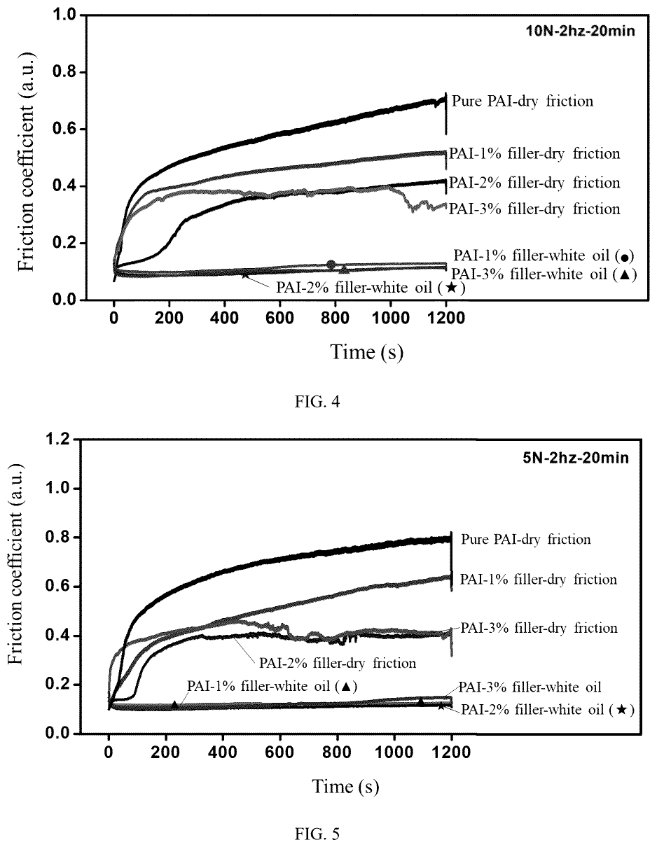

Under a load of 10 N, the test results of the friction coefficients for the three friction-reducing and wear-resistant polyamide-imide composite materials with different filler contents under the dry friction condition and the white oil condition are shown in FIG. 4. Correspondingly, the test results under a load of 5 N are shown in FIG. 5. MOS₂ is a self-lubricating material. The introduction of the biomass carbon material increases the hardness and overall stability of the material. Therefore, the friction coefficients of the PAI-1% filler, the PAI-2% filler, and the PAI-3% filler are significantly reduced. When the load is 10 N, average friction coefficients of the control group and the embodiments 1-3 are 0.5585, 0.4427, 0.3272, and 0.3597, respectively. The average friction coefficient of the embodiment 2 is reduced by over 40%. When the load is 5 N, the average friction coefficients of the control group and the embodiments 1-3 are 0.6654, 0.4924, 0.3649, and 0.4110, respectively. The average friction coefficient of the embodiment 2 is reduced by over 45%. The different friction coefficients of the embodiments 1-3 are due to the varying influence of different filler contents on the tribological performances of the polyimide-imide composite materials. Simultaneously, it can be observed that under the white oil condition, the friction coefficients of the embodiments 1-3 are all relatively low, which indicates that the prepared polyamide-imide composite materials have potential for use in high-temperature white oil environments.

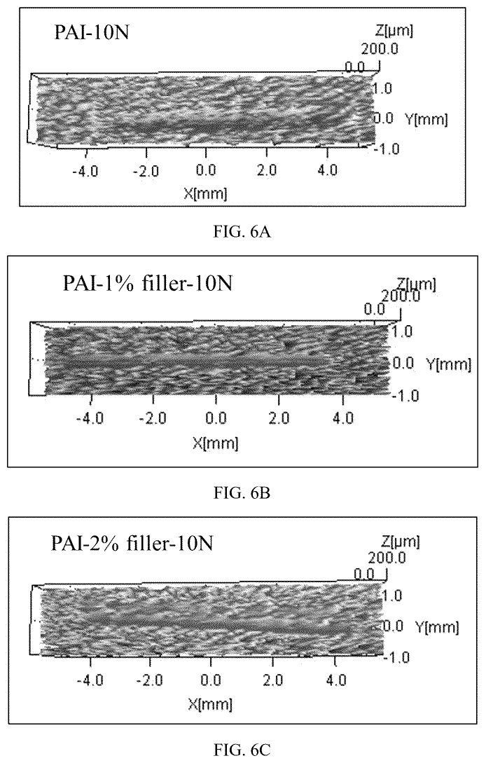

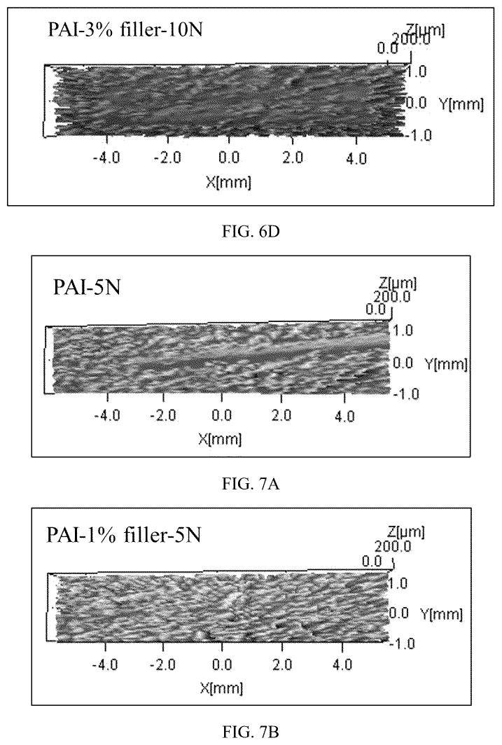

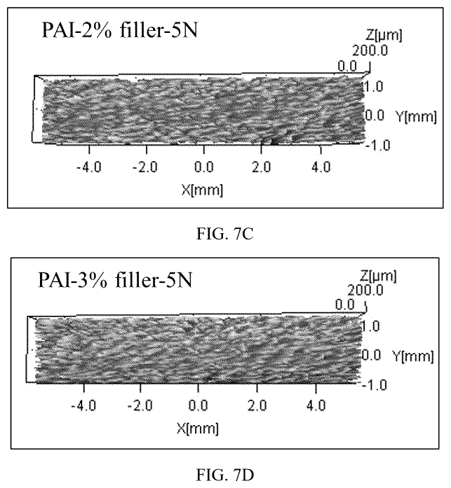

The wear under the dry friction condition with the load of 10 N for the three friction-reducing and wear-resistant polyamide-imide composite materials with different filler contents is shown in FIGS. 6A-6D. Correspondingly, the test results under the load of 5 N are shown in FIGS. 7A-7D. The pure polyamide-imide material is completely worn through after the friction test under the aforementioned conditions. However, as can be seen from FIGS. 6A-6D and FIGS. 7A-7D, after introducing the composite filler, the embodiments 1-3 all exhibits reduced wear, and no wear-through phenomenon occurred.

In summary, by introducing the cattail-derived carbon fiber composite MoS₂ material, the disclosure utilizes the self-lubricating property of MoS₂ itself combined with the stability and high load-bearing capacity advantages of this carbon material, which fully exerts the synergistic effect between the cattail-derived carbon fibers and MoS₂, thereby effectively controlling the friction coefficient and the wear rate of the polymer coatings. The friction-reducing and wear-resistant polyamide-imide composite material has broad application prospects in fields such as bearing outer coatings and mechanical engineering materials.

The foregoing has described some of the embodiments of the disclosure in detail. It should be understood that those skill in the art can make numerous modifications and variations based on the concepts of the disclosure without creative effort. Therefore, any technical solution that can be obtained by those skilled in the art through logical analysis, reasoning, or limited experimentation based on the concepts of the disclosure on the basis of the related art shall fall within a scope of protection defined by the claims.

1. A friction-reducing and wear-resistant polyamide-imide composite material, comprising the following raw materials in part by weight:
100 parts of basic slurry, 0.1-20 parts of functional filler, 0-50 parts of diluent, 0.1-1 part of defoamer, and 0.1-1 part of dispersant; wherein the basic slurry is aqueous polyamide-imide emulsion; the functional filler is a biomass carbon composite molybdenum disulfide material treated with a siloxane coupling agent, and a source of biomass carbon is derived from cattail-derived carbon fibers;
wherein a preparation method of the cattail-derived carbon fibers comprises: removing impurifies from surfaces of cattail fibers to obtain impurifies-removed cattail fibers, drying the impurifies-removed cattail fibers at a temperature of 700° C. to 900° C. for carbonization for 2 hours (h) to 4 h, to obtain the cattail-derived carbon fibers; and the cattail-derived carbon fibers have a microstructure and nanostructure; and
wherein a preparation method of the biomass carbon composite molybdenum disulfide material comprises: mixing the cattail-derived carbon fibers, ammonium molybdate tetrahydrate and thiourea in water to obtain a mixed solution; and performing a hydrothermal reaction on the mixed solution to obtain a crude product, and recycling and purifying the crude product to obtain the biomass carbon composite molybdenum disulfide material.

2. The friction-reducing and wear-resistant polyamide-imide composite material as claimed in claim 1, wherein the diluent is at least one of water, ethanol and isopropanol.

3. The friction-reducing and wear-resistant polyamide-imide composite material as claimed in claim 1, wherein the dispersant is at least one of HLD-6, HLD-8ks and HLD-11c.

4. The friction-reducing and wear-resistant polyamide-imide composite material as claimed in claim 1, wherein the defoamer is at least one of BYK-012, BYK-014 and BYK-016.

5. A preparation method of the friction-reducing and wear-resistant polyamide-imide composite material as claimed in claim 1, comprising:
step 1, mixing the cattail-derived carbon fibers, the ammonium molybdate tetrahydrate and the thiourea in water to obtain the mixed solution; and performing the hydrothermal reaction on the mixed solution to obtain the crude product, and recycling and purifying the crude product to obtain the biomass carbon composite molybdenum disulfide material;
step 2, treating the biomass carbon composite molybdenum disulfide material with the siloxane coupling agent, adding the biomass carbon composite molybdenum disulfide material treated with the siloxane coupling agent into the aqueous polyamide-imide emulsion to obtain a mixture, and adding the diluent, the dispersant and the deformer into the mixture to mix and disperse, to obtain a coating mixture; and
step 3, coating the coating mixture on a surface of a substrate, allowing the coated coating mixture to surface-dry at room temperature to obtain a surface-dried coating mixture, curing the surface-dried coating mixture to obtain a cured coating mixture, and annealing the cured coating mixture to obtain the friction-reducing and wear-resistant polyamide-imide composite material.

6. The preparation method of the friction-reducing and wear-resistant polyamide-imide composite material as claimed in claim 5, wherein, in step 1, an amount of the cattail-derived carbon fibers is in a range of 0.4 grams (g) to 1.0 g; an amount of the ammonium molybdate tetrahydrate is in a range of 0.6 g to 1.0 g, an amount of the thiourea is in a range of 1.8 g to 3.0 g, and a weight ratio between the ammonium molybdate tetrahydrate to the thiourea is 1:3; and an amount of the water is in a range of 40 milliliters (mL) to 60 mL.

7. The preparation method of the friction-reducing and wear-resistant polyamide-imide composite material as claimed in claim 5, wherein, in step 1, a temperature of the hydrothermal reaction is in a range of 150° C. to 200°° C., and a period of the hydrothermal reaction is in a range of 6 h to 12 h.

8. The preparation method of the friction-reducing and wear-resistant polyamide-imide composite material as claimed in claim 5, wherein, in step 3, a temperature of the curing is in a range of 270° C. to 320° C., and a period of the curing is in a range of 3 h to 8 h.

9. An application of the friction-reducing and wear-resistant polyamide-imide composite material as claimed in claim 1, comprising:
using the friction-reducing and wear-resistant polyamide-imide composite material as a friction-reducing and wear-resistant material in mechanical engineering.

10. An application of the friction-reducing and wear-resistant polyamide-imide composite material prepared by the preparation method of the friction-reducing and wear-resistant polyamide-imide composite material as claimed in claim 5, comprising:
using the friction-reducing and wear-resistant polyamide-imide composite material as a friction-reducing and wear-resistant material in mechanical engineering.
